(19) United States
(12) Patent Application Publication
(10) Pub. No.: US 2009/0258180 A1
(43) Pub. Date: Oct. 15, 2009

(54) LAYERED THERMALLY-INSULATING FABRIC WITH AN INSULATING CORE

(75) Inventor: Robert J. Goulet, Park City, UT (US)

Correspondence Address: Workman Nydegger;1000 Eagle Gate Tower, 60 East South Temple, Salt Lake City, UT, 84111, US

(73) Assignee: CHAPMAN THERMAL PRODUCTS, INC., Salt Lake City, UT (US)

(21) Appl. No.: 12/372,447

(22) Filed: Feb. 17, 2009

Related U.S. Application Data
(60) Provisional application No. 61/029,237, filed on Feb. 15, 2008.

(51) Int. Cl. B32B 1/06; D05B 97/00

(52) U.S. Cl. 428/72; 428/76; 112/475.01

(57) ABSTRACT

A composite fire-resistant and heat blocking article. The article includes at least two layers of a fire-retardant and heat-resistant fabric with a heat-barrier and/or heat-absorbing core material disposed between the fabric layers. The composite fire-resistant and heat blocking article provides durability, fire resistance, and the ability to withstand high heat exposure on one face for an extended period of time without transferring significant heat to the opposite face. Combining fire-retardant fabrics with a heat-barrier and/or heat-absorbing core material achieves a true synergy by offering greater fire and heat protection to persons and structures than either component can offer alone.

### CROSS-REFERENCE TO RELATED APPLICATION

This application claims priority to U.S. Provisional patent Application Ser. No. 61/029,237 filed Feb. 15, 2008 to Goulet entitled “LAYERED THERMALLY-INSULATING FABRIC WITH AN INSULATING CORE,” the disclosure of which is incorporated herein in its entirety.

### BACKGROUND OF THE INVENTION

1. The Field of the Invention

The present invention is in the field of fire retardant and heat resistant composite structures.

2. The Relevant Technology

Fire retardant articles are widely used to protect persons and structures. For example, fire retardant clothing is used to protect persons who are exposed to fire, particularly suddenly occurring and fast burning conflagrations. These include persons in diverse fields, such as race car drivers, military personnel, and fire fighters, each of which may be exposed to deadly fires and extremely dangerous incendiary conditions. For such persons, the primary line of defense against severe burns and even death is the protective clothing worn over some or all of the body. In the case of structures, fire resistant articles may be used to protect small areas form the heat associated with welding or plumbing repairs. There is also interest is the development of articles that could be used to cover an entire structure to protect it from fire damage such as from a forest fire.

Even though fire retardant clothing and articles presently exist, such clothing and articles do not always reliably offset the risk of severe burns, death, or total destruction if the person or structure is exposed to extreme heat for an extended period of time. This is due to the fact that while most clothing and articles are designed to prevent the person or structure from catching fire, the clothing and articles still permit significant amounts of heat to penetrate the garment or article.

A wide variety of different fibers and fibrous blends have been used in the manufacture of fire and heat resistant fabrics. Fire retardance, heat resistance, strength and abrasion resistance all play an important role in the selection of materials used to make such fabrics. However, it is difficult to satisfy all of the foregoing desired properties. There is often a compromise between fire retardance and heat resistance, on the one hand, and strength and abrasion resistance, on the other.

Conventional fire retardant fabrics on the market typically rate very high in one, or perhaps two, of the foregoing desired properties. One example is a proprietary fabric m-aramid fabric sold by DuPont, which rates high in strength and abrasion resistance at room temperature but only provides protection against high temperatures and flame for a relatively short period of time. When exposed to direct flame, the leading m-aramid “fire retardant” fabric begins to shrink and char in as little as 3 seconds, and the degradation of the fabric increases as the duration of exposure increases. Ironically, it is the tendency of m-aramid fabrics to char and shrink that is purported to protect the wearer's skin from heat and flame. M-aramid fabrics may protect the wearer from burns for several seconds, but becomes essentially worthless as a protective shield after it has begun to char, shrink and decompose. Once this occurs, large holes can open up through which flame and heat can pass, thus burning, or even charring, the naked skin of the person wearing the fabric. Fabrics based on p-aramid are also strong and resist abrasion at room temperature but also char and shrink when exposed to flame or high temperature.

Flammable fabrics such as cotton, polyester, rayon, and nylon can be treated with a fire retardant finish to enhance fire retardance. While this may temporarily increase the flame retardant properties of such fabrics, typical fire retardant finishes are not permanent. Exposure of the treated fabric to UV radiation (e.g., sun light) as well as routine laundering of the fabric can greatly reduce the fire retardant properties of the fabric. The user may then have a false sense of security, thus unknowingly exposing himself to increased risk of burns. There may be no objective way to determine, short of being caught in a fiery conflagration, whether a treated garment still possesses sufficient fire retardance to offset the risks to which the wearer may be exposed.

More recently, a range of highly fire retardant and heat resistant yarns and fabrics comprised of oxidized polyacrylonitrile fibers blended with one or more strengthening fibers were developed. Yarns and fabrics made exclusively from oxidized polyacrylonitrile fibers lack adequate strength for use in many applications. Blending oxidized polyacrylonitrile fibers with one or more types of strengthening fibers yields yarns and fabrics having increased strength and flexibility. U.S. Pat. Nos. 6,287,686 and 6,358,608 to Huang et al. disclose a range of yarns and fabrics that preferably include about 85.5-99.9% by weight oxidized polyacrylonitrile fibers and about 0.1-14.5% by weight of one or more strengthening fibers. U.S. Pat. No. 4,865,906 to Smith, Jr. includes about 25-85% oxidized polyacrylonitrile fibers combined with at least two types of strengthening fibers. For purposes of teaching fire retardant and heat resistant yarns, fabrics and articles of manufacture, the foregoing patents are incorporated herein by reference.

Highly flame retardant and heat resistant fabrics made according to the Huang et al. patents are sold under the name CARBONX by Chapman Thermal Products, Inc., located in Salt lake City, Utah. Such fabrics are able to resist burning or charring even when exposed to a direct flame. Fabrics made according to the Huang et al. and Smith, Jr. patents are not only superior to m-aramid fabrics as far as providing fire retardance and heat resistance, they are softer, have higher breathability, and are better at absorbing sweat and moisture. CARBONX feels much like an ordinary fabric made from natural or natural feeling synthetic fibers. M-aramid fabric, in contrast, feels more like wearing a plastic sheet than a fabric since it does not breathe well, nor does it wick sweat and moisture but sheds it readily.

Some applications may require a level of tensile strength, abrasion resistance, and durability not provided by conventional fire retardant fabrics. One way to improve such features is to incorporate a metallic filament, such as is disclosed in U.S. Pat. No. 6,800,367 and U.S. Pat. No. 7,087,300, both to Hanyon et al., the disclosures of which are incorporated by reference. Including a metal filament also increases the cut resistance of the fabric.

### BRIEF SUMMARY OF THE INVENTION

The present invention encompasses novel composite fire-resistant and insulative articles, methods of manufacturing such articles, and methods of use. The novel composite fire-resistant and insulative articles of the present invention combine durability, fire resistance, and the ability to withstand high heat exposure on one face for an extended period of time without transferring significant heat to the opposite face. The articles include at least two layers of a fire-retardant and heat-resistant fabric that are joined together such that there is a space in between the layers such that the space between the layers can be filled with an insulative and heat-resistant material. Combining fire-retardant fabrics with an insulative and heat-resistant core achieves a true synergy that offers greater fire protection than either component can offer alone.

In one embodiment, a composite fire-resistant and heat-blocking article is disclosed. The composite fire-resistant and heat-blocking article includes at least two layers of a fire-retardant and/or heat-resistant fabric forming a first face and a second opposite face, the at least two layers being joined together so as to form one or more open spaces between the at least two layers, and a heat-barrier and/or heat-absorbing core material disposed in the one or more open spaces between the at least two layers of fabric.

In one embodiment, a composite fire-resistant and heat-blocking article is characterized by the ability to withstand direct exposure to a flame or another heat source having a temperature of at least about 1500° C. on the first face for at least 10 minutes without transferring significant heat to the second opposite face. For example, the composite fire-resistant and heat-blocking articles described herein are able to protect a wood surface from charring by a flame having a temperature of at least about 1500° C. for at least 10 minutes, whereas a fire-retardant and heat-resistant fabric having no heat-diffusing and/or heat-reflective core material only protected the wood surface for about 10 seconds.

Suitable examples of heat-barrier and/or heat-absorbing materials that can be included in the composite fire-resistant and heat-blocking article described herein include, but are not limited to, aerogel, porous/insulating fire clay, pumice, spun refractory fibers, and combinations thereof. In a preferred embodiment, the heat-barrier and/or heat-absorbing material is silica aerogel.

In one embodiment, the heat-barrier and/or heat-absorbing material can be characterized as a heat-resistant material that is able to withstand a constant operating temperature of at least about 500° C. and having a thermal conductivity index in a range of about 0.4 W/mK to about 0.004 W/mK, preferably about 0.04 W/mK to about 0.01 W/mK, and more preferably about 0.03 W/mK to about 0.02 W/mK.

Suitable examples of fire-retardant and heat-resistant fabrics that can be used in the composites articles described herein include, but are not limited to, oxidized polyacrylonitrile (O-PAN), reinforced O-PAN, p-aramid, m-aramid, melamine, polybenzimidazole (PBI), polyimides, polyamideimides, partially oxidized polyacrylonitriles, novoloids, poly(p-phenylene benzobisoxazole) (PBO), poly(p-phenylene benzothiazoles) (PBT); polyphenylene sulfide (PPS), flame retardant viscose rayons, polyetheretherketones (PEEK), polyketones (PEK), polyetherimides (PEI), chloropolymeric fibers, modacrylics, fluoropolymeric fibers, and combinations thereof. In a preferred embodiment, the fire-retardant and heat-resistant fabric is reinforced O-PAN.

In one embodiment, the fire-retardant and heat-resistant fabric can further include plurality of metallic reinforcing fibers (e.g., steel monofilament) interwoven into the fire-retardant and heat-resistant fabric. The plurality of metallic reinforcing fibers that are interwoven into the fire-retardant and heat-resistant fabric can be the same or different than reinforcing fibers that are included in reinforced O-PAN.

Suitable examples of fire-retardant and heat-resistant fabrics include, but are not limited to, woven materials, such as woven fabrics, and non-woven materials, such as felted fabrics.

In one embodiment, the composite fire-resistant and heat-blocking article described herein can further include one or more layers of a heat-distributing and/or heat-reflective material disposed amongst the heat-barrier and/or heat-absorbing core material and between the first and second outer layers of the fire-retardant and heat-resistant fabric, the heat-distributing and/or heat-reflective material being selected from the group consisting of an aluminum foil, a metalized polyimide film, or a metalized fire-resistant fabric, and combinations thereof.

In an alternative embodiment, a composite fire-resistant and heat absorbing article can include at least two layers of a fire-retardant and heat-resistant fabric joined together so as to form a plurality of channels therebetween, and a heat-barrier and/or heat-absorbing core material disposed within the plurality of channels.

Suitable examples of fire-retardant and heat-resistant fabrics that can be included in the article described herein include fibers having a limiting oxygen index (LOI) of at least 50 such that the at least two layers of fire-retardant and heat-resistant fabric will not support combustion when exposed to a flame or another heat source.

In one embodiment, the plurality of channels in the composite fire-resistant and heat absorbing article are formed using a quilting process in which the first and second layers outer of fabric are sewn directly together such that each of the plurality of channels has an X-dimension, a variable Y-dimension, and a Z-dimension that is perpendicular to the XY plane and that runs the length of the channel.

In one embodiment, the plurality of channels in the composite fire-resistant and heat absorbing article are formed using a box quilting technique in which the first and second outer layers of fabric are joined using strips of fabric such that each of the channels has a box-like profile. In one embodiment, channels formed using a box quilting techniques have an X-dimension, a Y-dimension that is essentially constant, and a Z-dimension that is perpendicular to the XY plane and that runs the length of the channel.

In one embodiment, each of the plurality of channels can be filled with a heat-barrier and/or heat-absorbing material chosen from the group consisting of aerogel, insulating fire clay, pumice, spun refractory fibers, and combinations thereof.

In one embodiment, a method of making a composite fire-resistant and heat absorbing article includes (1) providing at least two sheets of a fire-retardant and heat-resistant fabric, (2) joining the at least two sheets of fabric together so as to form a first face and a second opposite face of the article and forming at least one channel between the two sheets of fabric, and (3) filling the channel with a heat-barrier and/or heat-absorbing core material such that the article is able to withstand direct exposure to a 1500° C. heat source on a first side of the article for up to 10 minutes without allowing transfer of significant heat to an opposite second side.

In one embodiment, the channel can be filled with a heat-barrier and/or heat-absorbing material selected from the group consisting of aerogel, insulating fire clay, pumice, spun refractory fibers, and combinations thereof.

Suitable examples of joining techniques include, but are not limited to, sewing the two layers of fabric together using a back-to-back quilting technique or a box quilting technique

In one embodiment, the method can further include (1) providing at least two composite fire-resistant and heat absorbing articles, and (2) overlaying the at least two articles on top of each other such that a void region in one article is occupied with a filled region from another article.

In another embodiment, the method can further include (1) providing a heat-distributing and/or heat-reflective material selected from the group consisting of an aluminum foil, a metalized polyimide film, or a metalized fire-resistant fabric, and combinations thereof, and (2) disposing the heat-distributing and/or heat-reflective material amongst the heat-barrier and/or heat-absorbing core material and between the first and second outer layers of the fire-retardant and heat-resistant fabric.

The composite fire-resistant and heat absorbing articles of the present invention can be incorporated into a wide variety of articles of manufacture. Examples include, but are not limited to, clothing, jump suits, gloves, hot pads, socks, welding bibs, fire blankets, floor boards, padding, protective head gear, linings, cargo holds, mattress insulation, drapes, insulating fire walls, and the like.

As such, one embodiment of the present invention includes a method for using a composite fire-resistant and heat absorbing article to protect a person from extreme heat or burning. Articles manufactured according to the present invention are capable of withstanding direct exposure to a flame or heat source on one face for up to 10 minutes without transferring significant heat to a second opposite face. It naturally follows that a method for protecting a person using a composite fire-resistant and heat absorbing article manufactured according to the present invention includes a step of draping the composite fire-resistant and heat absorbing article over an area that might be subject to burning. For example, articles of the present invention can be used to protect firefighters, welders, race car drivers, and other persons who may be exposed to extreme heat or flame sources for an extended period of time.

In another embodiment, the present invention includes a method of protecting a structure using a composite fire-resistant and heat absorbing article manufactured according to the present invention. A method of protecting a structure includes a step of draping a composite fire-resistant and heat absorbing article over an area that might be subject to burning. Articles manufactured and used according to the present invention may be used, for example, to protect a whole structure, such as a house, from catching fire in a blaze or to protect parts of a structure from burning during, for example, welding or plumbing repairs.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an exemplary composite fire-resistant and heat-blocking article according to one embodiment of the present invention;

FIG. 1B illustrates the composite fire-resistant and heat-blocking article of FIG. 1A in which the layers of the composite article are separated to show first and second outer layers of a fire-retardant and heat-resistant fabric and a heat-barrier and/or heat-absorbing core material;

FIG. 2 illustrates a cross-section of the composite fire-resistant and heat-blocking article shown in FIGS. 1A and 1B;

FIG. 3 illustrates a cross-section of a composite fire-resistant and heat-blocking article similar to the article depicted in FIG. 2, except the sheets of fabric are joined together with tabs of fabric at the edges such that the two layers are spaced apart;

FIG. 4 illustrates a cross-section of a composite fire-resistant and heat-blocking article made from two sheets of fire-retardant and heat-resistant fabric that are joined together to form a plurality of channels that are filled with an insulative and heat blocking material;

FIG. 5 illustrates a cross-section of a composite fire-resistant and heat-blocking article similar to the article depicted in FIG. 4, except two articles are overlayed on top of one another such that the void zones from one layer are filled thick zones from another layer; and

FIG. 6 illustrates a cross-section of a composite fire-resistant and heat-blocking article similar to the article depicted in FIG. 4, except the two sheets of fire-retardant and heat-resistant fabric that are joined together with tabs of fabric such that the two layers are spaced apart.

### DETAILED DESCRIPTION OF THE PREFERRED EMBODIMENTS

### I. Introduction and Definitions

The present invention encompasses novel composite fire-resistant and insulative articles, methods of manufacturing such articles, and methods of use. The novel composite fire-resistant and insulative articles of the present invention combine durability, fire resistance, and the ability to withstand high heat exposure on one face for an extended period of time without transferring significant heat to the opposite face. The articles include at least two layers of a fire-retardant and heat-resistant fabric that are joined together such that there is a space in between the layers such that the space between the layers can be filled with an insulative and heat-resistant material. Combining fire-retardant fabrics with an insulative and heat-resistant core achieves a true synergy by offering greater fire protection than either component can offer alone.

In general, heat degrades fibers and fabrics at different rates depending on fiber chemistry, the level of oxygen in the surrounding atmosphere of the fire, and the intensity of fire and heat. There are a number of different tests used to determine a fabric's flame retardance and heat resistance rating, including the Limiting Oxygen Index, continuous operating temperature, and Thermal Protective Performance.

The term “Limiting Oxygen Index” (or “LOI”) is defined as the minimum concentration of oxygen necessary to support combustion of a particular material. LOI is measured by passing a mixture of O₂ and N₂ over a burning specimen, and reducing the O₂ concentration until combustion is no longer supported. Hence, higher LOI values represent better flame retardancy. LOI is primarily a measurement of flame retardancy rather than temperature resistance. Temperature resistance is typically measured as the “continuous operating temperature.”

The term “continuous operating temperature” measures the maximum temperature, or temperature range, at which a particular fabric will maintain its strength and integrity over time when exposed to constant heat of a given temperature or range. For instance, a fabric that has a continuous operating temperature of 400° F. can be exposed to temperatures of up to 400° F. for prolonged periods of time without significant degradation of fiber strength, fabric integrity, and protection of the user. In some cases, a fabric having a continuous operating temperature of 400° F. may be exposed to brief periods of heat at higher temperatures without significant degradation. The presently accepted standard for continuous operating temperature in the auto racing industry rates fabrics as being “flame retardant” if they have a continuous operating temperature of between 375° F. to 600° F.

The term “fire retardant” refers to a fabric, felt, yarn or strand that is self extinguishing. The term “nonflammable” refers to a fabric, felt, yarn or strand that will not burn.

The term “Thermal Protective Performance” (or “TPP”) relates to a fabric's ability to provide continuous and reliable protection to a person's skin beneath a fabric when the fabric is exposed to a direct flame or radiant heat. The TPP measurement, which is derived from a complex mathematical formula, is often converted into an SFI rating, which is an approximation of the time it takes before a standard quantity of heat causes a second degree burn to occur.

The term “SFI Rating” is a measurement of the length of time it takes for someone wearing a specific fabric to suffer a second degree burn when the fabric is exposed to a standard temperature. The SFI Rating is printed on a driver's suit. The SFI Rating is not only dependent on the number of fabric layers in the garment, but also on the LOI, continuous operating temperature and TPP of the fabric or fabrics from which a garment is manufactured. The standard SFI Ratings are as follows:

| SFI Rating | Time to Second Degree Burn |
|---|---|
| 3.2A/1 | 3 Seconds |
| 3.2A/3 | 7 Seconds |
| 3.2A/5 | 10 Seconds |
| 3.2A/10 | 19 Seconds |
| 3.2A/15 | 30 Seconds |
| 3.2A/20 | 40 Seconds |

A secondary test for flame retardance is the after-flame test, which measures the length of time it takes for a flame retardant fabric to self extinguish after a direct flame that envelopes the fabric is removed. The term “after-flame time” is the measurement of the time it takes for a fabric to self extinguish. According to SFI standards, a fabric must self extinguish in 2.0 seconds or less in order to pass and be certifiably “flame retardant”.

The term “reinforced oxidized polyacrylonitrile” refers to O-Pan fibers, yarns, and fabrics that are manufactured from O-Pan that is reinforced with one or more strengthening fibers.

The term “tensile strength” refers to the maximum amount of stress that can be applied to a material before rupture or failure. The “tear strength” is the amount of force required to tear a fabric. In general, the tensile strength of a fabric relates to how easily the fabric will tear or rip. The tensile strength may also relate to the ability of the fabric to avoid becoming permanently stretched or deformed. The tensile and tear strengths of a fabric should be high enough so as to prevent ripping, tearing, or permanent deformation of the garment in a manner that would significantly compromise the intended level of thermal protection of the garment.

The term “abrasion resistance” refers to the tendency of a fabric to resist fraying and thinning during normal wear. Although related to tensile strength, abrasion resistance also relates to other measurements of yarn strength, such as shear strength and modulus of elasticity, as well as the tightness and type of the weave or knit.

The term “cut resistance” refers to the tendency of yarn or fabrics to resist being severed when exposed to a shearing force.

The terms “fiber” and “fibers”, as used in the specification and appended claims, refers to any slender, elongated structure that can be carded or otherwise formed into a thread. Fibers are characterized as being no longer than 25 mm. Examples include “staple fibers”, a term that is well-known in the textile art. The term “fiber” differs from the term “filament”, which is defined separately below and which comprises a different component of the inventive yarns.

The term “thread”, as used in the specification and appended claims, shall refer to continuous or discontinuous elongated strands formed by carding or otherwise joining together one or more different kinds of fibers. The term “thread” differs from the term “filament”, which is defined separately below and which comprises a different component of the inventive yarns.

The term “filament”, as used in the specification and appended claims, shall refer to a single, continuous or discontinuous elongated strand formed from one or more metals, ceramics, polymers or other materials and that has no discrete sub-structures (such as individual fibers that make up a “thread” as defined above). “Filaments” can be formed by extrusion, molding, melt-spinning, film cutting, or other known filament-forming processes. A “filament” differs from a “thread” in that a filament is, in essence, one continuous fiber or strand rather than a plurality of fibers that have been carded or otherwise joined together to form a thread. “Filaments” are characterized as strands that are longer than 25 mm, and may be as long as the entire length of yarn (i.e., a monofilament).

“Threads” and “filaments” are both examples of “strands”.

The term “yarn”, as used in the specification and appended claims, refers to a structure comprising a plurality of strands. The inventive yarns according to the invention comprise at least one high-strength filament and at least one heat resistant and flame retardant strand that have been twisted, spun or otherwise joined together to form the yarn. This allows each component strand to impart its unique properties along the entire length of the yarn.

The term “fabric”, as used in the specification and appended claims, shall refer to one or more different types of yarns that have been woven, knitted, or otherwise assembled into a desired protective layer.

When measuring the yarn, both volume and weight measurement may be applicable. Generally, volumetric measurements will typically be used when measuring the concentrations of the various components of the entire yarn, including threads and filaments, whereas weight measurements will typically be used when measuring the concentrations of one or more staple fibers within the thread or strand portion of the yarn.

The term “aerogel” refers to a low-density solid material derived from a gel in which the liquid component of the gel has been replaced with a gas. “Silica aerogel” is a silica-based aerogel that is derived from silica gel. Silica aerogel has an extremely low thermal conductivity index, which gives it remarkable insulative properties. The thermal conductivity index of silica aerogel ranges from about 0.03 Watts/meter-Kelvin (W/mK) down to about 0.004 W/mK depending on the density and the pore size of the aerogel. Silica aerogel can tolerate a constant operating temperature of about 500° C. and it begins to melt or degrade at about 1200° C.

The term “fire clay” refers to a refractory ceramic material that is typically used to line furnaces, kilns, fireboxes, and fireplaces. Fire clay usually contains about 30-80% aluminium oxide or alumina, and about 70-20% silicon dioxide, or silica; silicon carbide may also be present. Insulating fire clay is porous and correspondingly light form of fire clay with a low index of thermal conductivity. Insulating fire clay has a thermal conductivity index that ranges from about 0.2 W/mK to about 0.4 W/mK depending on the density of the material, with lower density materials having a lower thermal conductivity. Silica fire clay is able to withstand continued exposure to temperatures as great as about 1650° C.

The term “kaolin wool” refers to a fibrous refractory material that is typically formed into mats that resembles fiberglass insulation. Kaolin wool is produced from kaolin, a naturally occurring alumina-silica fire clay. Kaolin wools may also be manufactured by combining purified alumina, silica, zirconia, and/or chromium. Kaolin wools have a low index of thermal conductivity and can withstand continued exposure to temperatures as great as about 1400° C. The thermal conductivity index of kaolin wools ranges from about 0.02 W/mK to about 0.08 W/mK.

The term “pumice” refers to a volcanic rock that is a solidified frothy lava typically created when super-heated, highly pressurized rock is violently ejected from a volcano, expanded, and cooled rapidly. Depressurization creates bubbles by lowering the boiling point of the lava and simultaneous cooling freezes the bubbles in the matrix. Pumice is thermally stable and has remarkable insulative properties owing to its high porosity.

### II. Composite Fire-Resistant and Heat-Blocking Articles

In one embodiment, a composite fire-resistant and heat-blocking article is disclosed. An exemplary composite fire-resistant and heat-blocking article includes at least two layers of a fire-retardant and heat-resistant fabric forming a first face and a second opposite face, the at least two layers being joined together so as to form one or more open spaces between the at least two layers with a heat-barrier and/or heat-absorbing core material being disposed in the one or more open spaces between the at least two layers of fabric.

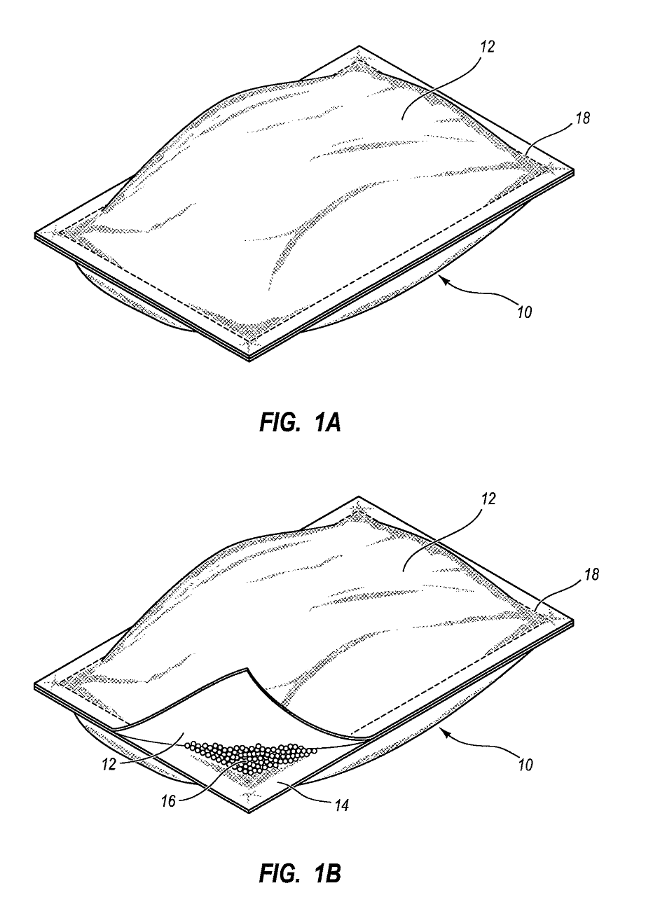

FIGS. 1A and 1B illustrate an exemplary composite fire-resistant and heat-blocking article 10 according to one embodiment of the present invention. FIG. 1A is a plan view of exemplary composite fire-resistant and heat-blocking article 10, and FIG. 1B shows the article 10 of FIG. 1A in which the layers of the composite fire-resistant and heat-blocking article 10 are separated to show the interior structure. The composite fire-resistant and heat-blocking article 10 depicted in FIGS. 1A and 1B includes a first layer of fire-retardant and heat-resistant fabric 12, a second layer of fire-retardant and heat-resistant fabric 14, and a core consisting of a heat-barrier and/or heat-absorbing material 16 disposed in between fabric layers 12 and 14.

In the embodiment depicted in FIGS. 1A and 1B, the fabric layers 12 and 14 are joined together to form a cavity between the layers that is filled with the heat-barrier and/or heat-absorbing material 16. The fabric layers of the article 10 are joined by stitching 18 around the edge of the article 10. One will appreciate, however, that other methods known in the art can be used to couple the various layers of the article 10 including, but not limited to, needle punching, gluing, riveting, stapling, and the like.

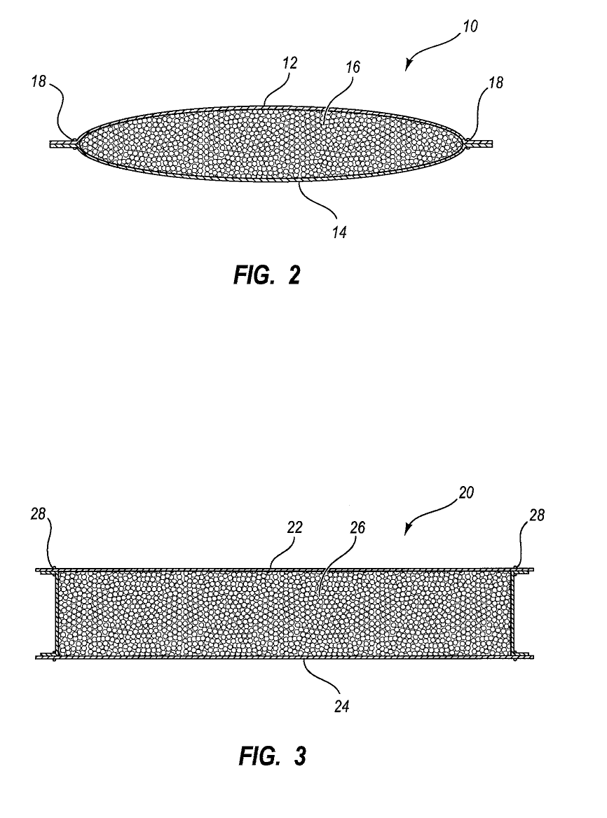

FIG. 2 is a cross-sectional view of the composite fire-resistant and heat-blocking article 10 depicted in FIGS. 1A and 1B. FIG. 2 clearly shows the first and second fabric layers 12 and 14, the heat-barrier and/or heat-absorbing material 16 disposed between fabric layers 12 and 14, and the stitching/seam area 18.

The composite fire-resistant and heat-blocking article illustrated in FIG. 2 is characterized by the ability to withstand direct exposure to a flame or another heat source having a temperature of at least about 1500° C. on the first face for at least 1 minute without transferring significant heat to the second opposite face.

Fire-retardant and heat-resistant fabric layers 12 and 14 provide a durable, preferably abrasion resistant, fire-resistant and heat-resistant outer layer for the article 10. The fire-retardant and heat-resistant fabric is chosen from the group consisting of oxidized polyacrylonitrile (O-PAN), reinforced O-PAN, p-aramid (e.g., Kevlar), m-aramid (e.g., Nomex), melamine (e.g., BASOFIL), polybenzimidazole (PBI), polyimides (e.g., KAPTON), polyamideimides (e.g., KERMEL), partially oxidized polyacrylonitriles (e.g., FORTAFIL OPF), novoloids (e.g., phenol-formaldehyde novolac), poly(p-phenylene benzobisoxazole) (PBO), poly(p-phenylene benzothiazoles) (PBT); polyphenylene sulfide (PPS), flame retardant viscose rayons, polyetheretherketones (PEEK), polyketones (PEK), polyetherimides (PEI), chloropolymeric fibers (e.g., FIBRAVYL L9F), modacrylics (e.g., PROTEX), fluoropolymeric fibers (e.g., TEFLON TFE), and combinations thereof. In a preferred embodiment, the outer fabric layers 12 and 14 are made from reinforced oxidized polyacrylonitrile, which is sold under the trade name CARBONX.

Reinforced oxidized polyacrylonitrile (i.e., CARBONX) is composed of oxidized polyacrylonitrile (O-PAN) fibers and at least one strengthening and/or reinforcing fiber. O-PAN fibers have tremendous fire-retardant and heat-resistant properties, but they lack tensile strength. Strengthening and/or reinforcing fibers or filaments may be included with O-PAN in order to increase the tensile strength of the resultant fibers. Fibers, yarns, and fabrics made of reinforced O-PAN are disclosed in a number of United States Patents, including U.S. Pat. Nos. 6,358,608, 6,827,686, 6,800,367, 7,087,300, and U.S. Pat. application Ser. No. 11/691,248, each of which is incorporated in their entirety herein by reference.

The O-PAN and the reinforcing fibers and/or strengthening filaments are blended together so as to form a fibrous blend having increased strength and abrasion resistance compared to a yarn, fabric, or felt consisting exclusively of oxidized polyacrylonitrile fibers. Preferably, O-PAN is included in an amount in an range from about 50 percent to about 99.9 percent by weight of the fiber blend with the remainder being made up of reinforcing fibers and/or strengthening filaments. More preferably, the fibrous blend includes O-PAN fibers in a range from about 75 percent to about 99.5 percent by weight of the fibrous blend, with the remainder consisting of reinforcing fibers and/or strengthening filaments. Even more preferably, the fibrous blend includes O-PAN fibers in a range from about 85 percent to about 99 percent by weight of the fibrous blend, with the remainder consisting of reinforcing fibers and/or strengthening filaments. Most preferably, the fibrous blend includes O-PAN fibers in a range from about 90 percent to about 97 percent by weight of the fibrous blend, with the remainder consisting of reinforcing fibers and/or strengthening filaments.

In one embodiment, the strengthening fibers include at least one of polybenzimidazole, polyphenylene-2,6-benzobisoxazole, modacrilic, p-aramid, m-aramid, a polyvinyl halide, wool, a fire resistant polyester, a fire resistant nylon, a fire resistant rayon, cotton, or melamine. In another embodiment, the strengthening filaments include at least one of metallic filaments, high strength ceramic filaments, high strength polymer filaments, and combinations thereof.

Reinforced O-PAN fibers may be assembled into woven fabric or non-woven felt materials. In one embodiment, at least one of the fabric layers may include a non-woven material. In another embodiment, at least one of the fabric layers may include a woven material.

In one embodiment, the fire-retardant and heat-resistant fabric can further include plurality of metallic reinforcing fibers (e.g., steel monofilament) interwoven into the fire-retardant and heat-resistant fabric. The plurality of metallic reinforcing fibers that are interwoven into the fire-retardant and heat-resistant fabric can be the same or different than reinforcing fibers that are included in reinforced O-PAN. In any case, the presence of metallic reinforcing fibers can substantially increase the tensile strength of the article when it is exposed to sustained heating as compared to articles that do not include metallic reinforcing fibers.

In one embodiment of the present invention, suitable examples of fire-retardant and heat-resistant fabrics that can be included in the article described herein include fibers having a limiting oxygen index (LOI) of at least 50 such that the at least two layers of fire-retardant and heat-resistant fabric will not support combustion when exposed to a flame or another heat source. As defined above, LOI refers to the minimum concentration of oxygen necessary to support combustion of a particular material. A fire-retardant and heat-resistant fabric having an LOI of 50 will not support combustion at an oxygen concentration lower than 50%. The Earth's atmosphere includes about 21% oxygen and a mix of other gases. This means that a fire-retardant and heat-resistant fabric having an LOI of 50 will generally not support combustion in the Earth's atmosphere.

The core 16 enhances the fire-resistant and heat-blocking characteristics of the article 10 in several potential ways. For example, core 16 is typically formed from materials having great temperature resistance (i.e., they can tolerate high constant operating temperatures) and great insulative properties. For example, the heat-barrier and/or heat-absorbing material can be characterized as a heat-resistant material that is able to withstand a constant operating temperature of at least about 500° C. and having a thermal conductivity index in a range of about 0.4 W/mK to about 0.004 W/mK, or preferably about 0.04 W/mK to about 0.01 W/mK, or more preferably about 0.03 W/mK to about 0.02 W/mK. The insulating core material can also block the passage of hot gases through the article 10 allowing them to diffuse rather than penetrating to the side away from the site where heat is applied.

Suitable examples of materials that can be used to form the core 16 include, but are not limited to, aerogel (e.g., silica aerogel), porous/insulative fire clay, pumice, spun refractory fibers (e.g., spun kaolin wool, an example of which is sold by Thermal Ceramics Co. under the brand name KAOWOOL-RT), and combinations thereof.

FIG. 3 illustrates a cross-sectional view of another embodiment of a composite fire-resistant and heat-blocking article 20 manufactured according to one embodiment of the present invention. The a composite fire-resistant and heat-blocking article 20 depicted in FIG. 3 is similar to the article 10 depicted in FIGS. 1A-2.

The composite fire-resistant and heat-blocking article 20 is formed from two layers of a fire-retardant and heat-resistant fabric 22 and 24 that are joined together to form a space therebetween. In the embodiment depicted in FIG. 2, the two sheets of fabric 22 and 24 are sewn together at the edges with tabs of fabric 28 that space the two sheets of fabric apart from one another as compared to the article depicted in FIG. 2 where the fabric layers 12 and 14 are sewn directly together. A heat-blocking and/or heat-absorbing material 26 fills the space between the two layers of fabric 22 and 24.

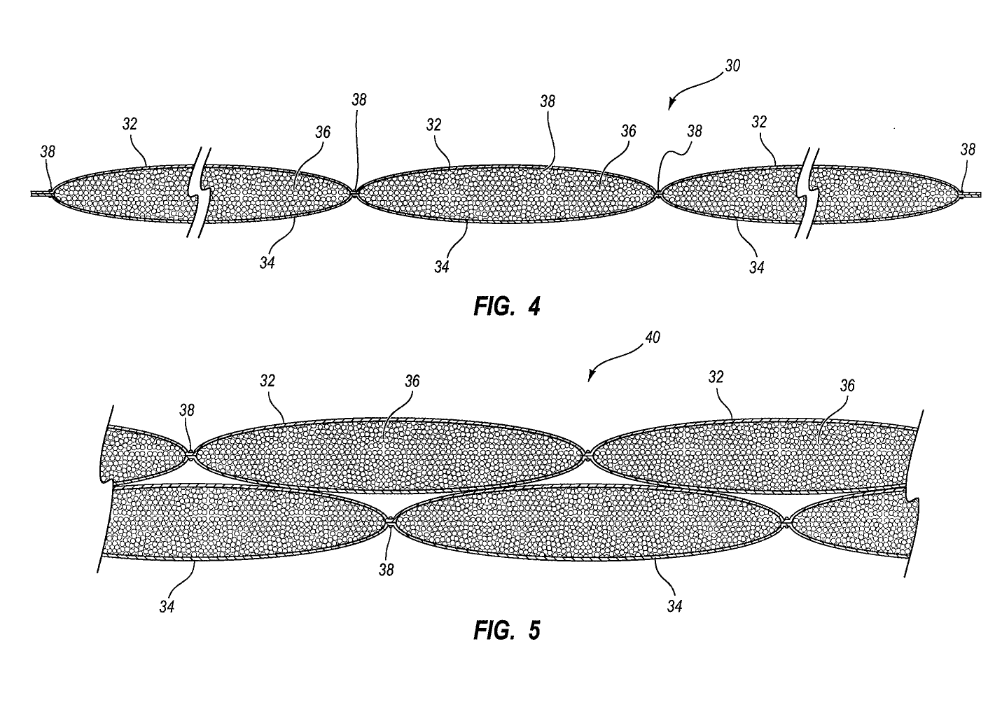

FIG. 4 illustrates a cross-sectional view of a composite fire-resistant and heat-blocking article 30 made from two sheets 32 and 34 of fire-retardant and heat-resistant fabric that are joined together to form a plurality of channels between the layers. The channels are filled with an insulative and heat blocking material 36.

In the embodiment depicted in FIG. 4, the sheets of fabric are joined directly together; a seam between two channels is depicted at 38. Joining the fabric layers 32 and 34 directly together creates a channel structure wherein each of the channels has an X-dimension, a variable Y-dimension, and a Z-dimension that is perpendicular to the XY plane and that runs the length of the channel. Preferably, the thickness in the variable Y-dimension is in an range from about 0.1 cm to about 10 cm. More preferably, the thickness in the variable Y-dimension is in an range from about 0.3 cm to about 7 cm. Most preferably, the thickness in the variable Y-dimension is in an range from about 0.5 cm to about 5 cm.

Joining the article 30 together in this manner is advantageous in that the article 30 is flexible along the Z-dimension. For example, the article 30 can be rolled up or molded around a structure. Nevertheless, the variable Y-dimension creates a situation in the filled article where the layer of insulative material is quite thick in some areas, while the area around the seams is essentially a void with no insulative material between the fabric layers. This translates to a situation where the center of the channel offers considerable heat protection while the seam region offers relatively little heat protection.

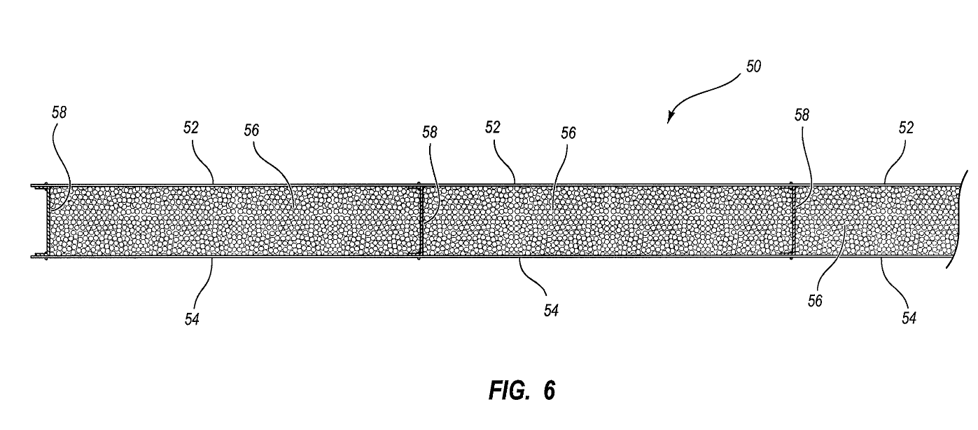

FIGS. 5 and 6 illustrate embodiments that are intended to ameliorate problems created by having voids near the seams. In one embodiment, FIG. 4 illustrates a cross-sectional view of a composite fire-resistant and heat-blocking article 40 wherein the voids in the seam region 38 are filled by overlaying at least two articles on top of one another. The articles are overlayed on top of one another such that the void zones from one layer are filled thick zones from another layer. Article 40 maintains flexibility in the Z-dimension while offering a more consistent level of heat protection across all areas of the article 40.

In another embodiment, FIG. 5 illustrates a cross-sectional view of a composite fire-resistant and heat-blocking article 50 in which the two layer of fire-retardant and heat-resistant fabric 52 and 54 are joined together with tabs of fire-retardant and heat-resistant fabric 58 such that the two layers 52 and 54 are spaced apart from one another. Joining the fabric layers 52 and 54 together with tabs of fabric 58 creates a channel structure wherein each of the channels has an X-dimension, an essentially constant Y-dimension, and a Z-dimension that is perpendicular to the XY plane and that runs the length of the channel. When the article 50 depicted in FIG. 5 is filled with insulative and heat blocking material 56, the filled article offers a consistent level of heat protection across all areas of the article. Preferably, the thickness in the essentially constant Y-dimension is in an range from about 3 cm to about 10 cm. More preferably, the thickness in the essentially constant Y-dimension is in an range from about 3.5 cm to about 7 cm. Most preferably, the thickness in the essentially constant Y-dimension is in a range from about 4 cm to about 5 cm.

In another embodiment, the insulative and/or heat blocking material may be combined with another type of heat blocking and or heat distributing material, such as a layer of metal foil, a metalized polyimide film, or a metalized fire-retardant and heat-resistant fabric. For example, an article could be made from a first layer of fire-retardant and heat-resistant fabric, a first layer of metal foil, a layer of insulative material, a second layer of metal foil, and a second outer layer fire-retardant and heat-resistant fabric. The metal foil may be positioned adjacent to the insulative material or it may be separated by a later of another material (e.g., a fire-retardant and heat-resistant fabric). Combining insulative and heat distributing materials provides a synergistic effect whereby heat from a point source is spread away from the point of application. This increases the effectiveness of the insulative material and increases burn through time.

Composite fire-resistant and heat-blocking articles prepared according to the present invention are able to withstand direct exposure to a 1500° C. flame source on a first side of the article for up to 10 minutes without allowing transfer of significant heat to an opposite second side.

### III. Methods of Making and Using Composite Fire-Resistant and Heat Absorbing Articles

In one embodiment, present invention includes a method of making a composite fire-resistant and heat absorbing article.

In one embodiment, the joining may be accomplished using any fastening means known in the art. For example, the layers may be joined using sewing, adhesives, metal grommet fasteners, staples, other fasteners known in the art, or combinations of the above. When the at least two sheets of fabric are joined back-to-back, each of the plurality of channels formed therebetween has an X-dimension, a variable Y-dimension, and a Z-dimension that is perpendicular to the XY plane and that runs the length of the channel.

One will of course appreciate that when fabric layers are joined directly together the filled article will include areas where the layer of heat insulative material between the fabric layers is relatively thick and void areas where there is essentially no insulative material between the fabric layers. One will also appreciate that the heat protection offered in these void areas is minimal. As such, the method further includes overlaying at least two articles on top of each other such that a void region in one article is occupied with a filled region from another article.

In another embodiment, the joining may include joining the at least two layers of fabric with sewing, adhesives, metal grommet fasteners, staples, or combinations of the above. Joining the at least two sheets of fabric together using a box-quilting technique creates an article wherein each of the plurality of channels formed therebetween has an X-dimension, an essentially constant Y-dimension, and a Z-dimension that is perpendicular to the XY plane and that runs the length of the channel.

The composite fire-resistant and heat absorbing articles of the present invention can be incorporated into a wide variety of articles of manufacture. Examples include, but are not limited to, clothing, jump suits, gloves, pot holders, socks, welding bibs, fire blankets, floor boards, padding, protective head gear, linings, cargo holds, mattress insulation, drapes, insulating fire walls, and the like.

As such, one embodiment of the present invention includes a method for using a composite fire-resistant and heat absorbing article to protect a person from extreme heat or burning. Articles manufactured according to the present invention are capable of withstanding direct exposure to a flame or heat source on one face for up to 10 minutes without transferring significant heat to a second opposite face. It naturally follows that a method for protecting a person using a composite fire-resistant and heat absorbing article manufactured according to the present invention includes a step of draping the composite fire-resistant and heat absorbing article over an area that might be subject to burning. For example, articles of the present invention can be used to protect firefighters, welders, race car drivers, and other persons who may be exposed to extreme heat or flame sources for an extended period of time.

In another embodiment, the present invention includes a method of protecting a structure using a composite fire-resistant and heat absorbing article manufactured according to the present invention. A method of protecting a structure includes a step of draping a composite fire-resistant and heat absorbing article over an area that might be subject to burning. Articles manufactured and used according to the present invention may be used, for example, to protect a flammable whole structure from catching fire in a blaze or to protect parts of a structure from burning during, for example, welding or plumbing repairs.

### EXAMPLES

The fire-resistant and heat-resistant properties of the articles of the present invention were demonstrated by determining the amount of time required to char wood with a flame having a temperature of about 1500° C. In the experiment, articles of the present invention were attached to a wood surface, a flame from an approximately 1500° C. torch was brought into contact with the article, and the time required to burn the underlying wood was determined. For the sake of comparison, controls consisting of unprotected wood and wood protected by two layers of fire-resistant CARBONX fabric were used. In the experiment, the unprotected wood charred almost instantly while the two layers of CARBONX prevented the wood from charring for about 10 seconds. In contrast, an article consisting of two layers of CARBONX with an approximately 5 cm thick aerogel core protected the wood surface from charring even after 10 minutes of exposure. This is a significant difference compared to the unprotected wood and CARBONX alone. Such a difference would provide a structure with considerable additional protection in the case of exposure to extreme heat, such as from a conflagration.

While the foregoing experiments used the ability to protect wood from charring as a model for fire and heat protection, it should be understood that the composite fire-resistant and heat-blocking articles described herein can also protect a person's skin. For instance, the ability to protect the skin was demonstrated by covering a person's hand with an article similar to the one depicted in FIG. 1A-2 (i.e., article 10) containing silica aerogel, placing a metal disc (e.g., a copper-plated zinc disc) on top of the article, and melting the disc with a torch. In the tests conducted, the metal disc was melted without burning the skin of the person's hand underneath. Moreover, the metal disc could be melted on top of the article without damaging the outer layer of fire-retardant fabric or the silica aerogel inside. The articles described herein, which can be incorporated into protective garments, can protect a wearer for greater periods of time than heat-resistant or fire-protective articles currently available on the market. Such a difference would provide a wearer with considerable additional protection in the case of exposure to extreme heat, such as from a conflagration.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A composite fire-resistant and heat-blocking article, comprising:
at least two layers of a fire-retardant and/or heat-resistant fabric forming a first face and a second opposite face, the at least two layers being joined together so as to form one or more open spaces between the at least two layers; and
a heat-barrier and/or heat-absorbing core material disposed in the one or more open spaces between the at least two layers of fabric.

2. A composite fire-resistant article as recited in claim 1, wherein the article is able to withstand direct exposure to a flame or another heat source having a temperature of at least about 1500° C. on the first face for up to 10 minutes without allowing transfer of significant heat to the second opposite face.

3. A composite fire-resistant article as recited in claim 1, wherein the heat-barrier and/or heat-absorbing material is selected from the group consisting of aerogel, insulating fire clay, pumice, spun refractory fibers, and combinations thereof.

4. A composite fire-resistant article as recited in claim 1, wherein the heat-barrier and/or heat-absorbing material is a heat-resistant material able to withstand a constant operating temperature of at least about 500° C. and having a thermal conductivity index in a range of about 0.4 W/mK to about 0.004 W/mK.

5. A composite fire-resistant article as recited in claim 1, wherein the heat-barrier and/or heat-absorbing material is a heat-resistant material able to withstand a constant operating temperature of at least about 500° C. and having a thermal conductivity index in a range of about 0.03 W/mK to about 0.02 W/mK.

6. A composite fire-resistant article as recited in claim 1, wherein the fire-retardant and heat-resistant fabric is selected from the group consisting of oxidized polyacrylonitrile (O-PAN), reinforced O-PAN, p-aramid, m-aramid, melamine, polybenzimidazole (PBI), polyimides, polyamideimides, partially oxidized polyacrylonitriles, novoloids, poly(p-phenylene benzobisoxazole) (PBO), poly(p-phenylene benzothiazoles) (PBT); polyphenylene sulfide (PPS), flame retardant viscose rayons, polyetheretherketones (PEEK), polyketones (PEK), polyetherimides (PEI), chloropolymeric fibers, modacrylics, fluoropolymeric fibers, and combinations thereof.

7. A composite fire-resistant article as recited in claim 1, further comprising a plurality of metallic reinforcing fibers interwoven into the fire-retardant and heat-resistant fabric.

8. A composite fire-resistant article as recited in claim 1, wherein at least one layer of the fire-retardant and heat-resistant fabric is a woven material.

9. A composite fire-resistant article as recited in claim 1, wherein at least one layer of the fire-retardant and heat-resistant fabric is a non-woven material.

10. A composite fire-resistant and heat-blocking article as recited in claim 1, the core material further including a heat-distributing and/or heat-reflective material disposed among the heat-barrier and/or heat-absorbing core material and between the first and second layers of fire-retardant and heat-resistant fabric, the heat-distributing and/or heat-reflective material being selected from the group consisting of aluminum foil, metalized polyimide film, metalized fire-resistant fabric, and combinations thereof.

11. A composite fire-resistant and heat blocking article, comprising:
at least two layers of a fire-retardant and/or heat-resistant fabric forming a first face and a second opposite face of the article, the at least two layers being joined together so as to form a plurality of channels therebetween; and
a heat-barrier and/or heat-absorbing core material disposed within at least one of the channels.

12. A composite fire-resistant and heat-blocking article as recited in claim 11, wherein the at least two layers of fire-retardant and heat-resistant fabric include fibers having a limiting oxygen index (LOI) of at least 50 such that the at least two layers will not support combustion in atmospheric air when exposed to a flame or another heat source.

13. A composite fire-resistant and heat-blocking article as recited in claim 11, wherein the fire-retardant and heat-resistant fabric is formed from reinforced oxidized polyacrylonitrile.

14. A composite fire-resistant and heat blocking article as recited in claim 11, wherein the least two layers of a fire-retardant and heat-resistant fabric are quilted together such that each of the plurality of channels has an X-dimension, a variable Y-dimension, and a Z-dimension that is perpendicular to the XY plane and that runs the length of the channel.

15. A composite fire-resistant and heat blocking article as recited in claim 11, wherein the fire-resistant fabric is box quilted such that each of the plurality of channels has an X-dimension, a Y-dimension that is essentially constant, and a Z-dimension that is perpendicular to the XY plane and that runs the length of the channel.

16. A composite fire-resistant and heat-blocking article as recited in claim 11, wherein the heat-barrier and/or heat-absorbing core material is selected from the group consisting of aerogel, insulating fire clay, pumice, spun refractory fibers, and combinations thereof.

17. A method of making a composite fire-resistant and heat blocking article, comprising:
providing at least two sheets of a fire-retardant and heat-resistant fabric;
joining the at least two sheets of fabric together so as to form a first face and a second opposite face of the article and forming at least one channel between the two sheets of fabric; and
position a heat-barrier and/or heat-absorbing core material between the two sheets so as to fill the channel,
wherein the article is able to withstand direct exposure to a 1500° C. heat source on a first side of the article for up to 10 minutes without allowing transfer of significant heat to an opposite second side.

18. A method as recited in claim 17, the heat-barrier and/or heat-absorbing material being selected from the group consisting of aerogel, insulating fire clay, pumice, spun refractory fibers, and combinations thereof.

19. A method as recited in claim 17, the joining further comprising sewing the at least two sheets of fabric back-to-back such that the at least one channel formed therebetween has an X-dimension, a variable Y-dimension, and a Z-dimension that is perpendicular to the XY plane and that runs the length of the channel.

20. A method as recited in claim 17, the joining further comprising sewing the at least two sheets of fabric together using a box-quilting technique such that each of the plurality of channels formed therebetween has an X-dimension, an essentially constant Y-dimension, and a Z-dimension that is perpendicular to the XY plane and that runs the length of the channel.

21. A method as recited in claim 17, further comprising:
providing at least two composite fire-resistant and heat absorbing articles; and
overlaying the at least two articles such that a void region in one article is occupied with a filled region from another article.

22. A method as recited in claim 17, further comprising:
providing a heat-distributing and/or heat-reflective material selected from the group consisting of aluminum foil, metalized polyimide film, metalized fire-resistant fabric, and combinations thereof; and
disposing the heat-distributing and/or heat-reflective material between the two sheets of fire-retardant and heat-resistant fabric.
